(19) United States
(12) Patent Application Publication
(10) Pub. No.: US 2009/0190328 A1
(43) Pub. Date: Jul. 30, 2009

(54) Thermal management of lamps in a backlight system

(76) Inventor: Donald Burris Clary, Rancho Palos, CA (US)

Correspondence Address: SANTOPIETRO, LOIS A.;E.I. DU PONT DE NEMOURS AND COMPANY, LegalPatent Records Centers, 4417 Lancaster Pike, Wilmington, DE, 19805, US

(21) Appl. No.: 10/585,685

(22) PCT Filed: Mar. 21, 2005
(86) PCT No.: PCT/US05/09288

§ 371 Date: Jul. 10, 2006

Related U.S. Application Data
(60) Provisional application No. 60/555,576, filed on Mar. 23, 2004.

(51) Int. Cl. G02F 1/13357

(52) U.S. Cl. 362/97.2

(57) ABSTRACT

A backlight system (300) having at least two juxtaposed cold cathode lamps (302) wherein the lamps comprise cathodes at each end and wherein the lamps are positioned in a manner that the cathodes are not touching. The lamps (302) could be longitudinally offset or one of lamps (302) may be shorter than the other lamp(s) resulting in the cathodes not touching.

### FIELD OF THE INVENTION

The present invention is directed to a lamp arrangement found in a display having a backlight system which includes at least two lamps having cathodes at each end and wherein the lamps are in a juxtaposed position and the cathodes of the lamps are not touching.

### BACKGROUND OF THE INVENTION

Liquid-crystal displays provided with a backlighting system that is thin and which allows for easy viewing of information on a screen are used with recent models of word processors or computers. The backlighting system in common use adopts an “edge lighting” method in which a linear light source such as a fluorescent tube is provided in proximity to one end portion of a transmissive light conducting plate or light guide. The purpose of the light guide in a liquid crystal display backlight is to bring in light from the side, bend it by approximately 90°, and distribute the light uniformly across the rear surface of an LCD. The most common type of devices that operate on the edge lighting method is shown in FIG. 1; wherein a cold cathode fluorescent (CCFL) lamp (104) is fixed in a housing (105) and the light from the lamp moves through an edge of the light guide (101) a plurality of light diffusing elements are formed in dots or stripes on one face of a light guide (101), which is almost entirely covered with a light diffusing and reflecting plate (103) whereas the opposite face of the light guide (from which light exits) is covered with a light diffusing sheet (102).

The most widely used CCFL lamps used in the industry today operate most efficiently at an optimum temperature of about 50° C. That is, more light is created from a given amount of electrical power at their optimum temperature than any other temperature. If the lamp deviates from its optimum temperature, for instance, it may operate colder or hotter from its optimum designated temperature, the light output diminishes, and drops off rapidly from its peak performance.

In a typical LCD configuration, as shown in FIG. 1, a backlight system will often have one lamp on each of the two long lateral sides of a rectangular light guide (two lamps total). In this case, the lamps typically will not exceed the optimum temperature. FIG. 2 shows an illustration of applications requiring more light; often two lamps (201) found in a juxtaposed position on each of the two long lateral sides of the light guide (4 lamps total). in this case, the lamps will typically operate at a temperature above the optimum, resulting in reduced light output. Juxtaposed position means placed side-by-side or adjacent. The hottest region of the CCFL lamp is at the ends, where the cathodes are located. If the paired lamps are placed in contact with an acrylic light guide (202), the cathodes may slightly melt the acrylic where the cathodes touch the acrylic. This is because the two cathodes are generating a great deal of heat in a small area. Therefore, there is a need for a configuration wherein the heat may be dissipated avoiding heat buildup.

The foregoing general description and the following detailed description are exemplary and explanatory only and are not restrictive of the invention, as defined in the appended claims.

### SUMMARY OF THE INVENTION

The invention is directed to a backlight system comprising: at least two juxtaposed cold cathode lamps wherein each lamp comprises cathodes at each end and wherein the lamps are positioned in a manner that the cathodes are not touching. The invention is further directed to a system of wherein the lamp cathodes are juxtaposed and longitudinally offset. The system is still further directed to wherein the lamps are juxtaposed and are not touching, or wherein the lamps are juxtaposed and are touching but the cathodes are offset.

### BRIEF DESCRIPTION OF THE DRAWING

FIGS. 1, 2, 5 and 7 illustrate current lamp arrangements in backlight systems of liquid crystal displays.

FIGS. 3, 4, 6 and 8 illustrate embodiments of backlight systems of the present invention.

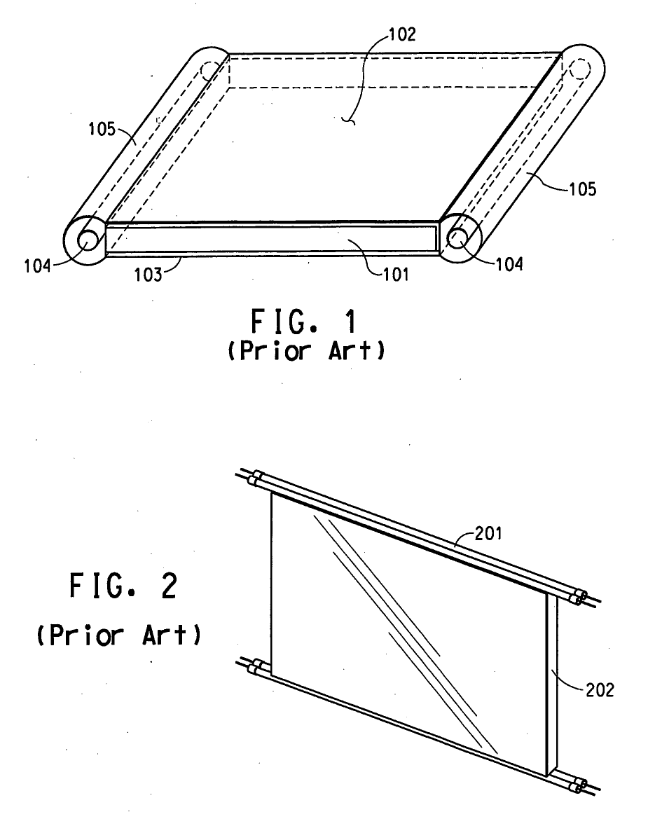

### DETAILED DESCRIPTION OF THE INVENTION

Cold cathode fluorescent lamps (CCFLs) are often used in a backlighting system. The miniature lamps can be long straight cylinders in a range of 1.8 mm to 4 mm in diameter, and a length from 25 mm to 400 mm. The straight cylinders may be formed into L or U bend lamps. Cold cathode lamps have no special heating circuits in the cathode regions (at each end of the lamps). The CCFL lamp, generally, is typically a high efficiency lamp that utilizes an electrical discharge through mercury vapor to produce ultra-violet energy. The ultraviolet energy excites phosphor materials applied as a thin layer on the inside of a glass tube. The excited phosphor materials allow the light to be visible. The ends of the glass tube are capped with a cathode structure that typically has a pin connection.

A light guide is a light conducting structure having light scattering elements disposed on a light conducting substrate that transports light from a light source into the light guide, bends the light rays and distributes the light across the rear surface of a display. Synonymous with the phrase “wave guide”. The light guide of this invention can be made of any material that exhibits transparency or semi-transparency and is capable of light transmission. Suitable materials include, but are not limited to, quartz, glass, or light transmissive resins (e.g., acrylic or polycarbonate). A non-limiting example of a specific acrylic resin that is suitable is polymethyl methacrylate (PMMA).

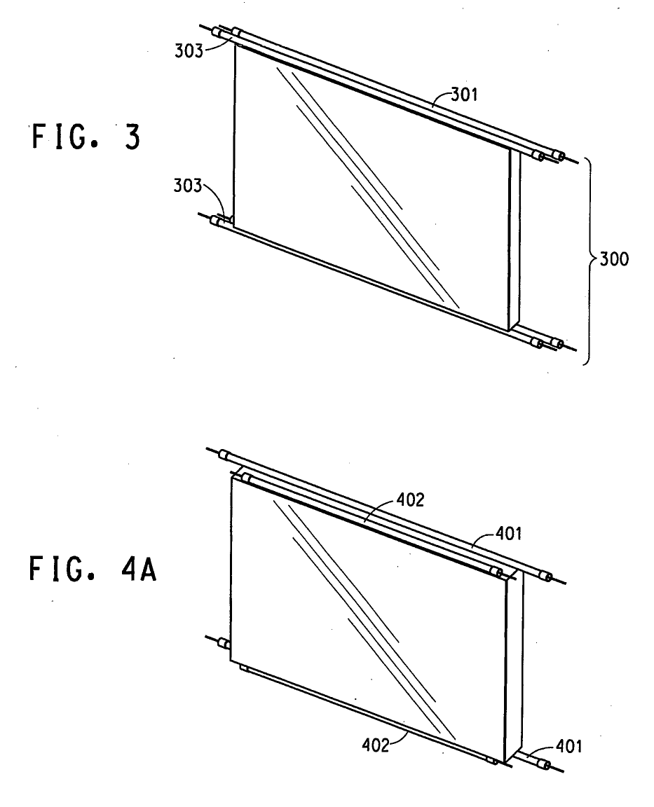

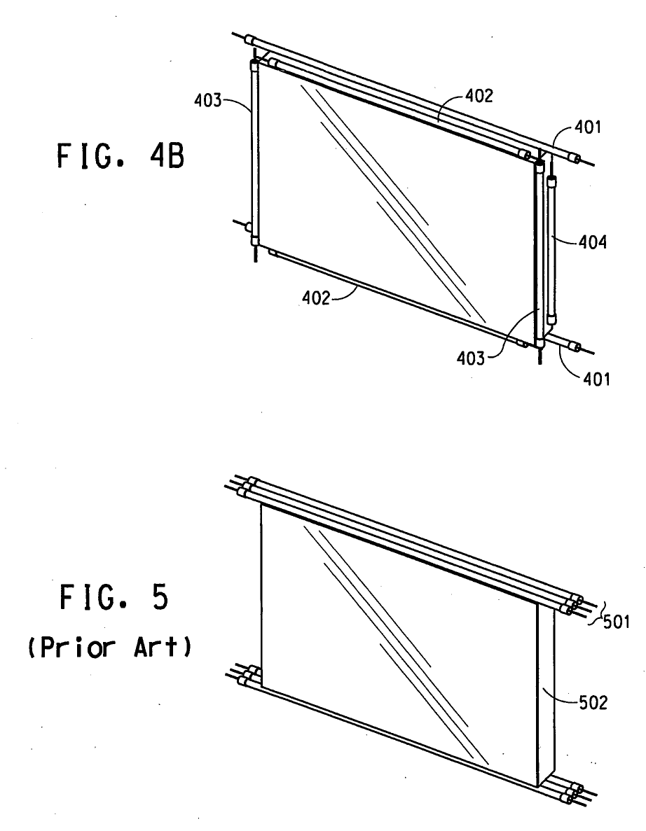

FIG. 3 illustrates one embodiment of the present invention wherein a backlight system (300) includes at least a light guide (302) and an opposing pair of CCFL lamps (303). The opposing pair of lamps is found on a set of opposing lateral sides if the light guide. One (301) of the lamps in the pair is juxtaposed and shifted longitudinally or longitudinally offset. In the offset position, the cathodes are not touching each other and are generating the same amount of heat as if in the parallel position, but the heat is dissipated over a much larger area, wherein the lamps operate cooler and closer to their optimum temperature producing optimum light output. When one lamp of a pair of equal length lamps is longitudinally offset, the cathodes at the other end are offset by an equal amount. In another embodiment as shown in FIGS. 4A and 4B. The lamps are positioned by making one of lamps (402) shorter than the other lamp (401) wherein the cathodes do not meet on opposing lateral sides of a light guide as shown in 4A; or on all lateral sides as shown in 4B. Thus, you get thermal benefits at both ends of the paired lamps. For example, CCFLs with cathodes that do not touch gives a luminance gain of about 20% as compared to the same pair with the cathodes positioned side by side to each other.

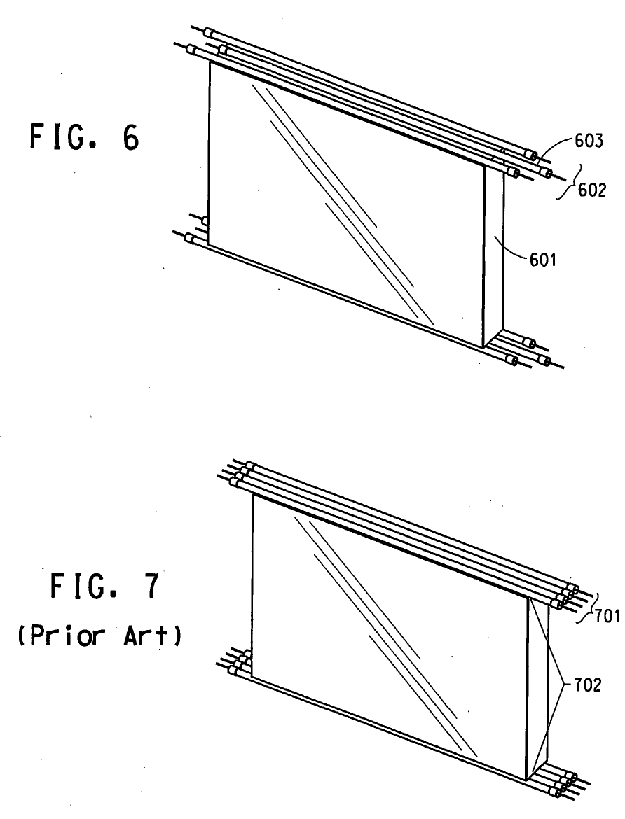

In another embodiment, the thermal management concept is further illustrated. FIG. 5 illustrates a trio (501) of CCFLs placed on a set of two long lateral sides of a light guide (6 lamps total), the lamps reach optimum temperature at about 10 seconds from power turn-on, resulting in a drop in light output as the lamps overheat from continued use. Therefore, this would not be a practical arrangement. In contrast, when the concept of the present invention is applied, as shown in FIG. 6, the light guide (601) thickness is adjusted to compensate for lamp positioning. The lamps are placed so that the cathodes of the lamps are not touching (602) wherein the center lamp of a 3-lamp trio is longitudinally offset relative to the outside lamp (603) of the trio, the lamps run cool and make an effective design. In another embodiment it is possible to position three lamps per side by making the center of the trio shorter wherein the cathodes do not meet or by making the center lamp longer avoiding direct contact of the cathodes.

In another embodiment of the thermal management concept is further illustrated. FIG. 7 places 4 lamps (701) of CCFLs on each of the two long lateral sides of a light guide (702) (8 lamps total), the thermal management becomes impractical with the passive cooling techniques. This can be remedied by place two lamps side by side but not longitudinally offset on each of the 4 lateral sides of the light guide which will decrease the amount of heat created by the cathodes.

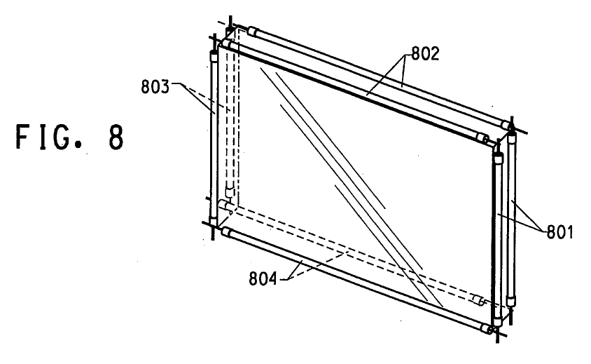

However, FIG. 8 illustrates the present invention wherein a pair of lamps are arranged on each of the 4 lateral sides of a rectangular light guide (801, 802, 803, 804) (8 lamps total), wherein one lamp is longitudinally shifted of each of the four pairs, resulting in an 8 lamps embodiment operating at an efficient temperature. In another embodiment, the lamps are arranged on each of the 4 lateral sides of a rectangular light guide with cathodes not touching and the lamps are not longitudinally shifted but one of lamps is shorter than the other lamp resulting in the cathodes of the lamps not touching.

In conclusion, lamps become more efficient in a backlight system comprising at least two juxtaposed cold cathode lamps wherein each lamp comprises cathodes at each end and wherein the lamps are positioned in a manner that the cathodes are not touching. Also, it is desirable to offset the cathodes by longitudinal offset or making at least one of lamps shorter than the other lamp(s).

We claim:

1. A backlight system comprising at least two juxtaposed cold cathode lamps wherein the lamps comprise cathodes at each end and wherein the lamps are positioned in a manner that the cathodes are not touching.

2. The system of claim 1 wherein the cathodes are longitudinally offset.

3. The system of claim 1 wherein the lamps are not touching.

4. The system of claim 1 wherein the lamps are touching.

5. The system of claim 1. wherein one of lamps is shorter than the other lamp(s).

6. The system of claim 1 further comprising a light guide.

7. The system of claim 6 wherein there are at least two juxtaposed cold cathode lamps on at least one set of opposing lateral sides of the light guide and wherein one lamp of the pair is longitudinally offset from the other so that the cathodes of the lamps are not touching.

8. The system of claim 6 wherein there are at least two juxtaposed cold cathode lamps forming a pair on each lateral side of the light guide.

9. The system of claim 6 wherein there are at least three juxtaposed cold cathode lamps having a center lamp and two end lamps on at least one set of opposing lateral sides of the light guide and wherein the center lamp is longitudinally offset from the end lamps so that the cathodes of the lamps are not touching.

10. The system of claim 6 wherein there are at least three juxtaposed cold cathode lamps having a center lamp and two end lamps on each lateral side of the light guide and wherein-the center lamp is longitudinally offset from the end lamps so that the cathodes of the lamps are not touching.

11. A device comprising the system of claim 1.
